(19) United States
(12) Patent Application Publication
(10) Pub. No.: US 2026/0368058 A1
(43) Pub. Date: Nov. 19, 2026

(54) METHODS AND DEVICES FOR DISPLAYING SERVER TROUBLESHOOTING INFORMATION

(71) Applicant: Aivres Systems Inc., San Jose, CA (US)

(72) Inventor: Yung Yu Lai, New Taipei City (TW)

(21) Appl. No.: 19/208,920

(22) Filed: May 15, 2025

(51) Int. Cl. G06F 11/32; G03B 21/14; G06F 11/30

(52) U.S. Cl. CPC G06F 11/328; G03B 21/145; G06F 11/3055

(57) ABSTRACT

The present disclosure relates to systems and techniques to display information, and more specifically, to integrated input/output (I/O) devices (e.g., a display module) for facilitating server maintenance and troubleshooting operations. In an implementation, a computing device is provided. The computing device can include a control device and an input/output (I/O) device coupled to the control device. The I/O device can include a projector. The control device can be configured to: determine a status of the computing device; activate the projector in response to determining that the status is abnormal; and transmit information associated with the status to the projector for display.

### BACKGROUND

Computing devices, such as servers, are widely used in various fields. With the rapid development of technology, server applications have been integrated into everyone’s lives today. As a result, in some implementations, the need for efficient server maintenance and troubleshooting has become increasingly important. The maintenance and troubleshooting process can involve a range of activities performed by technicians or engineers to ensure the server’s performance and reliability. When the server encounters a technical issue (e.g., a hardware failure) or needs an operating system recovery, the technicians may rely on some input/output (I/O) modules or devices of the server to diagnose the technical issue quickly or complete the recovery task. A delay in the server maintenance and troubleshooting can cause server owners or customers to suffer economic loss. Therefore, solutions that can help reduce server maintenance and troubleshooting time and improve overall service reliability are desired.

### SUMMARY

The present disclosure relates to systems and techniques to display information, and more specifically, to integrated input/output (I/O) devices (e.g., a display module) for facilitating server maintenance and troubleshooting operations.

In an implementation, a computing device is provided. The computing device can include a control device and an input/output (I/O) device coupled to the control device. The I/O device can include a projector. The control device can be configured to: determine a status of the computing device; activate the projector in response to determining that the status is abnormal; and transmit information associated with the status to the projector for display.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages and/or benefits. In some implementations, a projector and a laser projection keyboard are integrated into an I/O device of a server, thereby providing immediate input and display functionalities and enhancing the efficiency of server maintenance and operations. First, the laser projection keyboard can provide a physical input method, allowing technicians to configure or troubleshoot the server quickly without an external keyboard. Second, using the projector of the I/O device, the technicians can obtain instant access to the display without needing an external monitor. For example, even without an external monitor, the I/O device can still project server status information or basic input/output system (BIOS) information onto a nearby wall or other display surfaces, enabling the technicians to view server performance and error messages directly. Thus, the described techniques are suitable for data centers or server rooms with confined spaces and can be used to reduce server maintenance and configuration time. Third, in some other implementations (e.g., during field maintenance), the described techniques can eliminate the trouble to carry and setup additional external I/O hardware. Fourth, the technicians can check server information (e.g., for routine management and/or urgent repairs) in a more flexible way and respond promptly even when they are on the move. In summary, the described I/O device and information display techniques provide an efficient, convenient, and flexible solution for server management, significantly improving the productivity of server operations and reducing server downtime.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIGS. 1A-1B show a computing device, according to some implementations of the present disclosure.

FIG. 2 is a side view of the computing device of FIGS. 1A-1B, according to some implementations of the present disclosure.

FIG. 3 is a flowchart illustrating an example of a computer-implemented method for displaying server information, according to some implementations of the present disclosure.

FIGS. 4A-4C illustrate an activation process of a projector, according to some implementations of the present disclosure.

FIGS. 5A-5D illustrate functions of a laser projection keyboard, according to some implementations of the present disclosure.

FIG. 6 shows another example of a computing device, according to some implementations of the present disclosure.

FIGS. 7A-7B show examples of sizes of a computing device an input/output (I/O) device, according to some implementations of the present disclosure.

FIG. 8 is a block diagram illustrating a computer-implemented system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The following detailed description describes systems and techniques to display information and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as not to obscure one or more described implementations. The present disclosure is not intended to be limited to the described or illustrated implementations, but to be accorded the widest scope consistent with the described principles and features.

In conventional server designs, peripheral interfaces (e.g., video graphics array (VGA) and universal serial bus (USB)) can be provided to allow technicians to connect external input/output (I/O) devices (e.g., a monitor, a keyboard, or a mouse) for troubleshooting purposes. Such interfaces can be placed on the front side or the rear side of the server. The use of external I/O devices provides an intuitive and efficient local operating environment during server maintenance and troubleshooting. Using the local operating environment, the technicians can directly access the server’s operating system and basic input/output system (BIOS) settings without relying on remote management tools, especially in cases where the server cannot connect to the network or remote control fails. In some implementations, the technicians can instantly view server health, error reports, and system logs using a VGA display, and perform configuration changes, software installation, or troubleshooting using the input hardware such as a keyboard and a mouse. The local operations can be especially important when the server has a hardware failure or requires an operating system recovery. In some implementations, even when the server is in a low-level system state (e.g., without the network or remote access), the compatibility and stability of VGA and USB interfaces can still ensure that critical information is displayed, providing the technicians with tools to resolve issues quickly.

However, not every server is configured with additional external I/O devices that are readily available. In some instances, the technicians may not have sufficient time to find the external I/O devices and connect them to the server. During an emergency situation, without the help of a VGA monitor, a keyboard, and a mouse, the technicians may not quickly and effectively locate the cause of a server issue. As such, relying on the additional external I/O devices may affect the server maintenance efficiency and extend server downtime during troubleshooting. Thus, solutions that can help reduce server maintenance and troubleshooting time and improve overall service reliability are desired.

The present disclosure relates to systems and techniques to display information, and more specifically, to integrated I/O devices (e.g., a display module) for facilitating server maintenance and troubleshooting operations. In one implementation, a computing device (e.g., a server) is provided. The computing device can include a control device and an I/O device coupled to the control device. For example, the I/O device can include a projector. The control device can be configured to determine a status of the computing device, activate the projector in response to determining that the status is abnormal, and transmit information associated with the status to the projector for display.

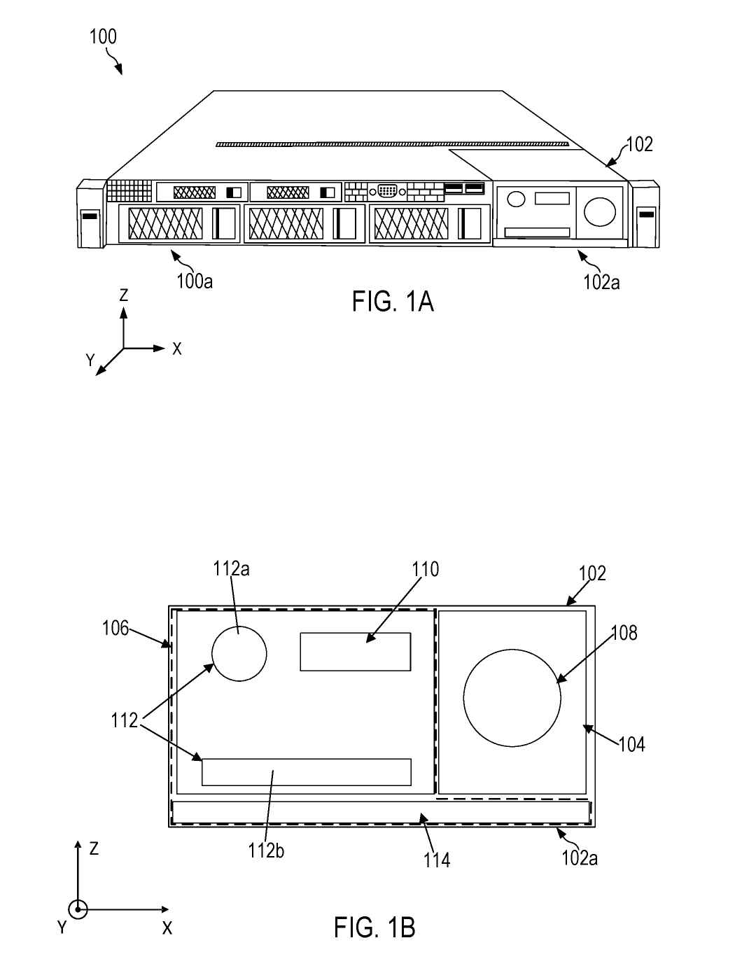

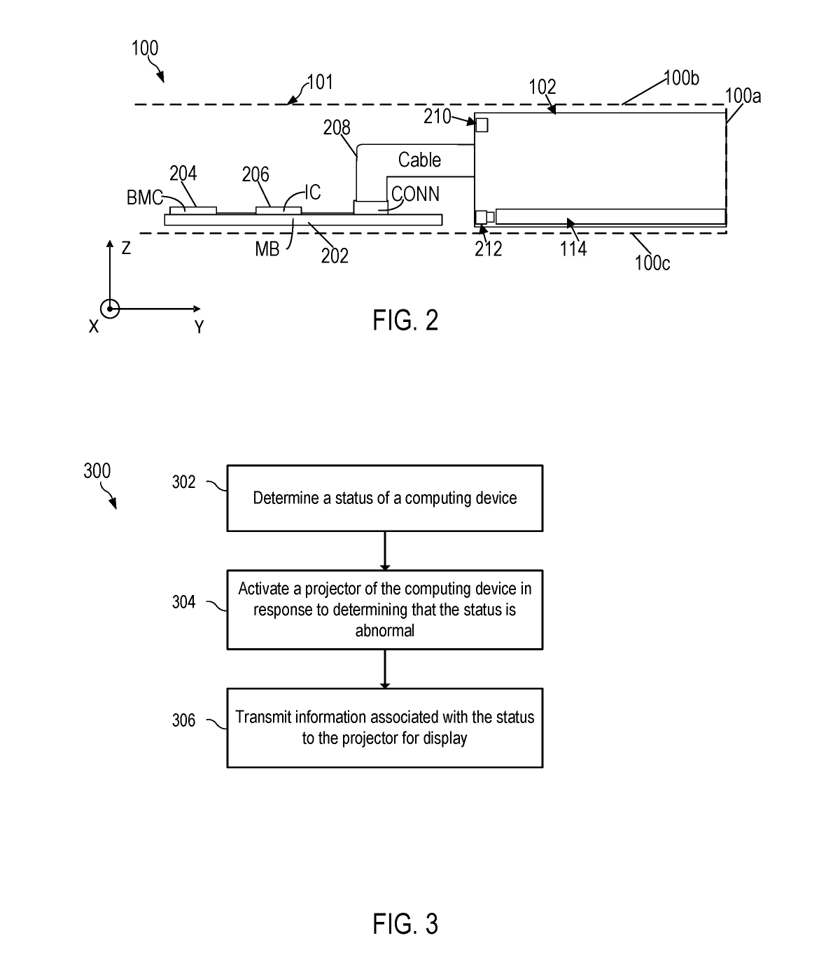

FIGS. 1A-1B show a computing device 100, according to some implementations of the present disclosure. It is noted that X, Y, and Z axes (also referred to as X, Y, and Z directions) are included in FIGS. 1A-1B to further illustrate the spatial relationship of various components in the computing device 100. The X direction is perpendicular to the Y direction, and the Z direction is perpendicular to both the X and Y directions. The computing device 100 can include two lateral surfaces extending laterally in the X-Y plane: a top surface (also called a top side, e.g., top side 100b of FIG. 2) and a bottom surface (also called a bottom side, e.g., bottom side 100c of FIG. 2). In some implementations, the bottom side is positioned in the lowest plane of the computing device 100 in the Z direction. As used herein, whether one component (e.g., a layer or a device) of the computing device 100 is “on,” “above,” or “below” another component (e.g., a layer or a device) of the computing device 100 is determined relative to the Z direction (the vertical direction perpendicular to the X-Y plane, e.g., the thickness direction of the computing device 100). The same notion for describing the spatial relationships is applied throughout the present disclosure.

FIG. 1A is an exterior view of the computing device 100. In some implementations, the computing device 100 can be a server. For example, the computing device 100 can be designed to provide services, data, or resources to other computers (also called clients) over a network. While not shown in FIG. 1, in some implementations, multiple servers (e.g., each server can be an implementation of the computing device 100) can be mounted in a rack or a cabinet to form a server system. The computing device 100 can include a control device (e.g., control device 204 as described with reference to FIG. 2) and an input/output (I/O) device 102 coupled to the control device. As shown in FIG. 1A, the I/O device 102 can be mounted in the computing device 100 in such a way that a side 102a of the I/O device 102 is aligned with a side 100a (e.g., a front side or a rear side) of the computing device 100. In the example of FIG. 1A, the side 100a is the front panel of the computing device 100. In some other implementations, the side 100a can be the back panel of the computing device 100. Both the side 102a and the side 100a extend along the X direction and the Z direction. In some implementations, as shown in FIG. 1A, peripheral interfaces and ventilation windows can also be arranged on the side 100a of the computing device 100. The side 102a of the I/O device 102 can be configured to interface components of the I/O device 102 (e.g., a projector and/or a laser projection keyboard as described below) with outside of the computing device 100.

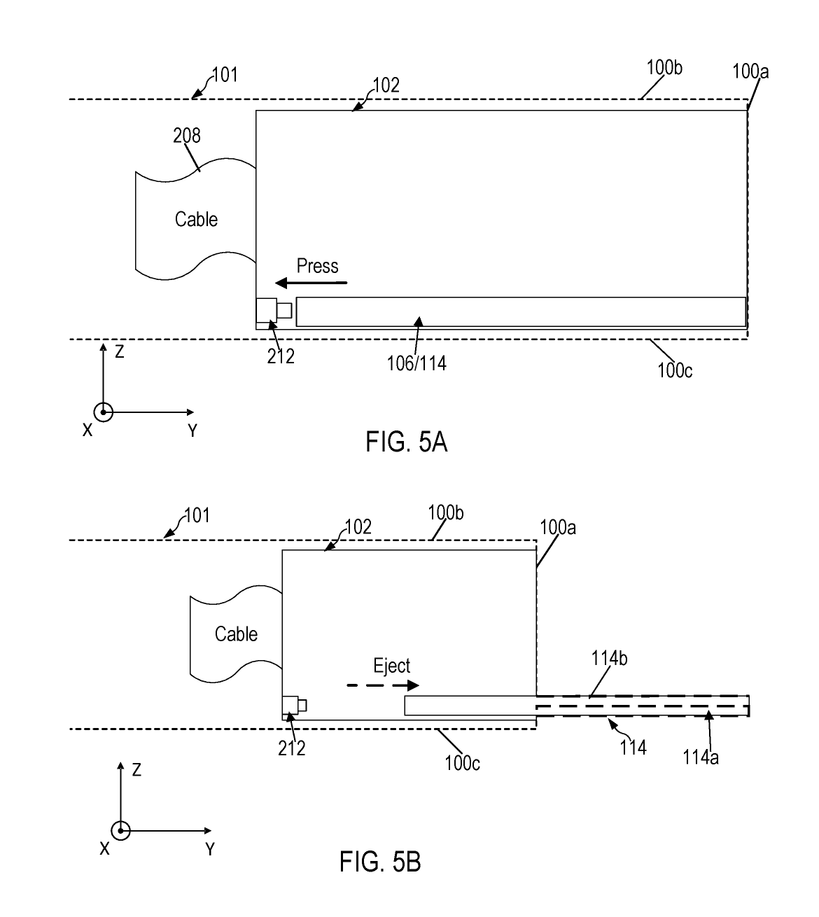

FIG. 1B shows an enlarged view of the side 102a of the I/O device 102. The I/O device 102 can include a projector 104 and a laser projection keyboard 106. The projector 104 includes one or more lenses 108. The laser projection keyboard 106 can be configured to detect gestures of a user (e.g., the technician who operates the computing device 100) and to input data based on the detected gestures. As shown in FIG. 1B, the laser projection keyboard 106 can include a laser source 110, one or more motion sensors 112, and a retractable platform 114. The laser source 110 can be configured to project an image of a keyboard pattern or layout onto a surface (e.g., as shown in FIG. 5D). In some implementations, the laser source 110 can use low-intensity laser rays to create a visible outline of the keyboard layout. This projection can allow the user to see where each key is located and interact with the keyboard pattern as if the keyboard were physically present. The motion sensors 112 can detect gestures of the user (e.g., the user’s finger movements). In some implementations, the motion sensors 112 can pick up infrared light reflected off the user’s fingers when the user touches the projected keys. By determining a location of the reflected infrared light, the motion sensors 112 can determine which key is pressed by the user and generate input data accordingly.

In some implementations, the laser projection keyboard 106 can have multiple motion sensors 112 (e.g., motion sensors 112a and 112b as shown in FIG. 1B) to enhance detection accuracy and responsiveness. In some implementations, the multiple motion sensors can be configured to detect movements along different directions. For example, the motion sensor 112a can detect vertical movements (e.g., up and down along the Z direction), and the motion sensor 112b can detect horizontal movements (e.g., forward, backward, left, and right in the X-Y plane). Alternatively, in some other implementations, each of the motion sensors 112a and 112b can be configured to detect both vertical movements and horizontal movements. Such a configuration can provide redundancy and reliability. For example, if one of the motion sensors 112a and 112b fails or is obstructed, another motion sensor may still detect the gestures of the user, ensuring that the laser projection keyboard 106 remains functional.

FIG. 2 shows a side view of the computing device 100, according to some implementations of the present disclosure. A dashed line 101 represents a location and a boundary of the computing device 100’s case. For example, the case of the computing device 100 can have the side 100a (e.g., as described with reference to FIG. 1A), a top side 100b, and a bottom side 100c. Both the top side 100b and the bottom side 100c extend laterally in the X-Y plane. As shown in FIG. 2, the computing device 100 can include the I/O device 102, a motherboard 202, a control device 204, and a converter 206. Although not shown in FIG. 2, the computing device 100 can further include other components or modules such as one or more processors, one or more memories, one or more storage devices, and one or more graphics cards, etc. The motherboard 202 is the main circuit board that connects the computing device 100’s internal and external components and allows them to communicate with each other. For example, the control device 204 and the converter 206 are connected to the motherboard 202. In some implementations, each of the control device 204 and the converter 206 can be considered as part of the motherboard 202. The control device 204 can be any suitable device that is configured to control one or more components of the computing device 100. For example, the control device 204 can be a baseboard management controller (BMC). The BMC is a microcontroller that provides out-of-band management of the computing device 100. In some implementations, the BMC can provide administrators with remote access and control over hardware, for example, even when the computing device 100 is powered off or unresponsive. In some implementations, the BMC can be accessible by the administrators via a dedicated Ethernet (or LAN) port or a shared network interface, thereby allowing secure remote connections. The BMC can communicate with other components through an I²C (Inter-Integrated Circuit, also called I2C) interface, which is a synchronous, multi-master, multi-slave, serial communication protocol used for communication between microcontrollers and peripheral devices.

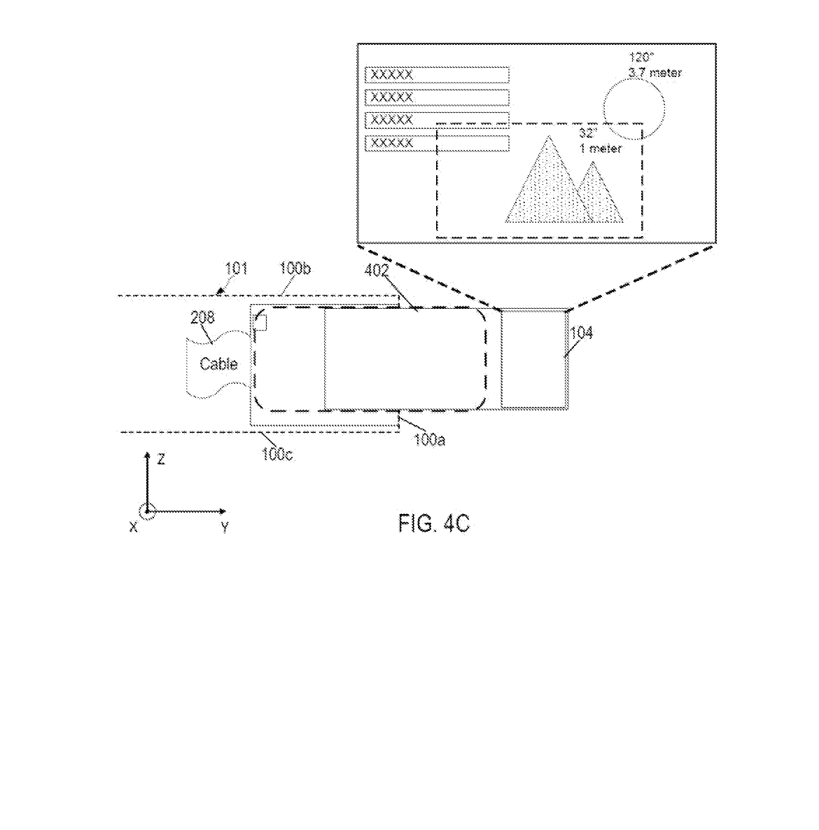

As shown in FIG. 2, in some implementations, the I/O device 102 can be connected to the motherboard 202 via a cable 208 (also referred to as a wire-to-board connection). Alternatively, in some other implementations, the I/O device 102 can be directly connected to the motherboard 202 (also referred to as a board-to-board connection) or connected to the motherboard 202 via any other suitable connectors. In some implementations, the I/O device 102 can include a motor 210 that drives the projector 104. The I/O device 102 can further include a switch 212 that controls and interacts with the laser projection keyboard 106. Functions of the motor 210 are described in detail below with reference to FIGS. 4A-4C. Functions of the switch 212 are described in detail below with reference to FIGS. 5A-5D.

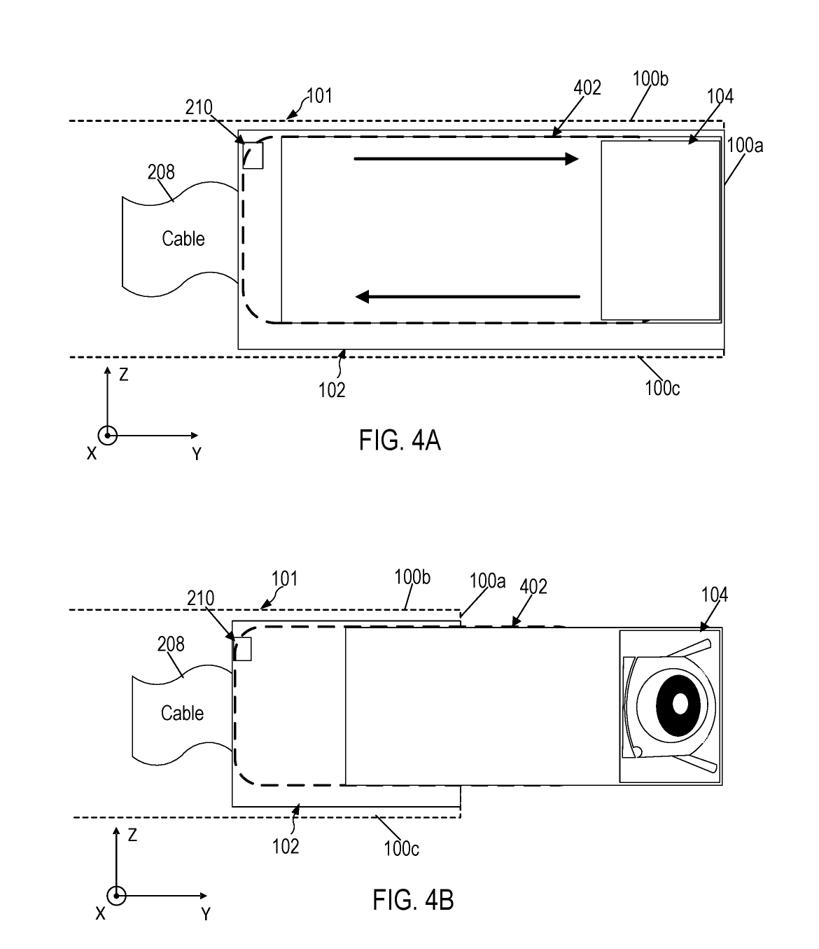

FIG. 3 is a flowchart illustrating an example of a computer-implemented method 300 for displaying server information, according to some implementations of the present disclosure. For clarity of presentation, the method 300 is performed by a computing device (e.g., the computing device 100 of FIG. 1A or FIG. 2), and the description that follows generally describes method 300 in the context of the other figures in this disclosure. However, it is understood that method 300 can be performed, for example, by any system, environment, software, and hardware, or a combination of systems, environments, software, and hardware, as appropriate. In some implementations, various steps of method 300 can be run in parallel, in combination, in loops, or in any order. In some implementations, the computing device can perform one or more, or all of the processes described in the method 300. As shown in FIG. 2, the computing device 100 can include the control device 204 and the I/O device 102 coupled to the control device 204. As shown in FIG. 1B, the I/O device 102 can include the projector 104.

At 302, the computing device 100 can determine (e.g., by using the control device 204) a status of the computing device 100. For example, the status can be a normal status, indicating that the computing device 100 is running in a normal operating condition. In another example, the status can be an abnormal status, indicating that the computing device 100 experiences a problem or an issue has occurred when the computing device 100 is running.

At 304, the computing device 100 can activate (e.g., by using the control device 204) the projector 104 in response to determining that the status is abnormal.

FIGS. 4A-4C illustrate an activation process of the projector 104, according to some implementations of the present disclosure. As shown in FIG. 4A, the dashed line 101 represents the location and the boundary of the computing device 100’s case. For example, the case of the computing device 100 can have the side 100a (e.g., as described with reference to FIG. 1A), the top side 100b, and the bottom side 100c. The side 100a extends vertically in the X-Z plane. Both the top side 100b and the bottom side 100c extend laterally in the X-Y plane. The I/O device 102 can include the motor 210 and a retractable housing 402. The projector 104 can include a detector, a light source, and one or more lenses (e.g., as shown in FIG. 4B). The detector of the projector 104 can also be referred to as a sensing module. The detector of the projector 104 can be hosted in the retractable housing 402. In some implementations, all components of the projector 104 including the detector, the light source, and the lens(es) can be hosted in the retractable housing 402. The retractable housing 402 can be driven by the motor 210 and move along the Y direction. For example, the motor 210 can drive the retractable housing 402 using a telescopic chain drive (not shown in FIG. 4A) or any other suitable driving parts or driving methods. Before the activation of the projector 104, the retractable housing 402 is located inside the computing device 100’s case 101. FIG. 4A also shows the cable 208, which can be used to connect the I/O device 102 to the motherboard 202 (e.g., as shown in FIG. 2).

The method 300 can include determining, by the detector of the projector 104, a display surface outside of the computing device 100. In some implementations, when the projector 104 is activated or turned on, the motor 210 can be configured to expand the retractable housing 402. For example, as shown in FIG. 4B, the retractable housing 402 can slide (e.g., driven by the motor 210) along a horizontal direction (e.g., the Y direction) and can place the projector 104 in a position beyond the side 100a of the computing device 100. Then, the projector 104 can use its detector to determine the display surface outside of the computing device 100 (e.g., an external display surface). For example, after the projector 104 is extended, the detector can scan a surrounding area of the computing device 100 to locate or identify a suitable display surface. The display surface can be a vertical wall, a screen, or any other suitable planar surface adjacent to the computing device 100. In some implementations, a distance between the projector 104 and the display surface can be measured or determined by the projector 104 (e.g., by using the detector). The projector 104 can adjust its configuration (e.g., orientation, focus of lens(es), or other projection parameters) based on the distance to optimize the display. Optimization of the display can include determining an appropriate projection size and making the display image clear. For example, as shown in FIG. 4C, when the display surface is further away from the projector 104 (e.g., the distance between the projector 104 and the display surface is 3.7 meters), the projection size can be increased (e.g., 120″). When the display surface is closer to the projector 104 (e.g., the distance is1 meter), the projection size can be reduced (e.g., 32″). In some implementations, the lens(es) of the projector 104 can be adjusted manually (e.g., by the technician).

Returning to the flowchart in FIG. 3, at 306, the computing device 100 can transmit (e.g., by using the control device 204) information associated with the status to the projector 104 for display. Accordingly, the projector 104 can receive the information associated with the status from the control device 204. Then, the projector 104 can project the information associated with the status on the display surface (e.g., as shown in FIG. 4C). The information associated with the status can include any suitable information related to operations and management of the computing device 100, such as information indicating the status, log data related to the status, or diagnostic information related to the status, etc. In some implementations, the information projected to the display surface can include system status information, maintenance instructions, or any other relevant content that can be used to assist the technician in server maintenance and troubleshooting operations. In some implementations, when the projector 104 is not in use or after the troubleshooting operations are completed, the control device 204 or the projector 104 can send a control signal to the motor 210. In response to the control signal, the motor 210 can move the retractable housing 402 back to the inside of the computing device 100 (e.g., at the original position as shown in FIG. 4A).

By using the integrated projector 104 to locate the display surface and display the information associated with the status on the display surface, the computing device 100 no longer relies on the additional external I/O devices in maintenance and troubleshooting operations. Thus, this approach can provide the technician with immediate access to critical maintenance and troubleshooting related information, thereby improving the server maintenance and troubleshooting efficiency.

In some implementations, the projector 104 can directly receive the information associated with the status from the control device 204. In some other implementations, the projector 104 can receive the information associated with the status from the control device 204 via a chip or device (e.g., the converter 206 of FIG. 2) coupled between the control device 204 and the I/O device 102. In some instances, the converter 206 can serve as a translator or an interface between the I/O device 102 and the control device 204. In other words, the converter 206 can be configured to convert data from the I/O device 102 to a format (e.g., an I2C protocol or an improved inter-integrated circuit (I3C) protocol) supported by the control device 204.

In some implementations, the converter 206 can support a backup function. The converter 206 can receive the information associated with the status of the computing device 100 from the control device 204 (e.g., a BMC). Then, the converter 206 can store the received information. In this way, when the control device 204 is inactive, the converter 206 can still transmit the stored information to the I/O device 102 (e.g., for display). In other words, this design allows the converter 206 to read and store information from the control device 204. In the event of a CPU failure or a BMC failure, the converter 206 may still operate normally. The converter 206 can communicate efficiently with the control device 204 with low power consumption (e.g., via the I3C protocol), ensuring smooth information transmission. In some implementations, the converter 206 and the control device 204 can operate independently, allowing the converter 206 to continuously monitor hardware status, sensor data, and other critical information even if the CPU of the computing device 100 fails. Additionally, the backup function of the converter 206 allows it to receive information from the control device 204, store relevant system failure information in its internal memory, and send the information to the I/O device 102 for display if the control device 204 fails. Furthermore, in some implementations, the converter 206 can have a data enhancement function, which can be used to optimize data processing and generate visual effects in image signals to be sent to the I/O device 102 for display. These described features can significantly improve the computing device 100’s reliability and stability, ensuring that system information is not lost in the event of a CPU failure or a BMC failure, optimizing emergency response and continuous operation capabilities, while providing higher quality display effects.

In some implementations, the technician can manage a server system including multiple servers, and each server can be an example of the computing device 100. In this case, when the server system encounters an issue, the described techniques can be used to identify which server of the server system needs to be checked. For example, the technician can locate the server of interest by looking for a server with an activated or ejected projector or laser projection keyboard or by checking the information projected to a nearby display surface.

FIGS. 5A-5D illustrate functions of the laser projection keyboard 106, according to some implementations of the present disclosure. As shown in FIG. 5A, the dashed line 101 represents the location of the computing device 100’s case. For example, the case of the computing device 100 can have the side 100a (e.g., as described with reference to FIG. 1A), the top side 100b, and the bottom side 100c. The side 100a extends vertically in the X-Z plane. Both the top side 100b and the bottom side 100c extend laterally in the X-Y plane. The I/O device 102 includes the switch 212 and the laser projection keyboard 106. The switch 212 can control and interact with the laser projection keyboard 106. When a user or a technician wants to use the laser projector keyboard 106, the user can apply a pressure to the retractable platform 114. The retractable platform 114 can first move towards the switch 212 along the Y direction and trigger the switch 212 to turn on the power supply of the laser projection keyboard 106. This way, the power consumption can be reduced because the power supply is not provided when the laser projection keyboard 106 is not in use.

After triggering the switch 212, as shown in FIG. 5B, a part of the retractable platform 114 can eject or extend to the outside of the case 101 along the Y direction. The movement of the retractable platform 114 can be driven, for example, by an internal spring. Now the laser projection keyboard 106 is operational and can be used to input data. The retractable platform 114 can have multiple parts (e.g., parts 114a and 114b as shown in FIG. 5B). When the retractable platform 114 is within the case 101, the parts 114a and 114b can be folded so that the retractable platform 114 has a compact form and occupies less space. When the retractable platform 114 extends to the outside of the case 101, as shown in FIG. 5C, the parts 114a and 114b can be unfolded (e.g., either automatically or manually by the user) to form a surface with more space for the keyboard projection. The surface can extend in the X-Y plane. While FIG. 5C shows that the surface is formed by a center part 114a and two side parts 114b, this example is for illustration purpose only and is not intended to be construed in a limiting sense. In practice, any suitable folding and unfolding design can be applied to the retractable platform 114. In some implementations, the surface formed by the unfolded parts 114a and 114b can be a flat surface or a substantially flat surface with minor deviations or irregularities (e.g., slightly curved) but is still suitable for typing. In some implementations, the parts 114a and 114b can have uneven or irregular surfaces, but the surface formed by the unfolded parts 114a and 114b can be flat or substantially flat. As shown in FIG. 5D, the laser projection keyboard 106 can activate the laser source 110 and the motion sensor(s) 112. The laser projection keyboard 106 can use the laser source 110 to project a keyboard pattern on the surface formed by the unfolded parts 114a and 114b. When the user types on the keyboard pattern, input data can be generated by using the motion sensor(s) 112 based on interactions between the user’s gestures and the keyboard pattern.

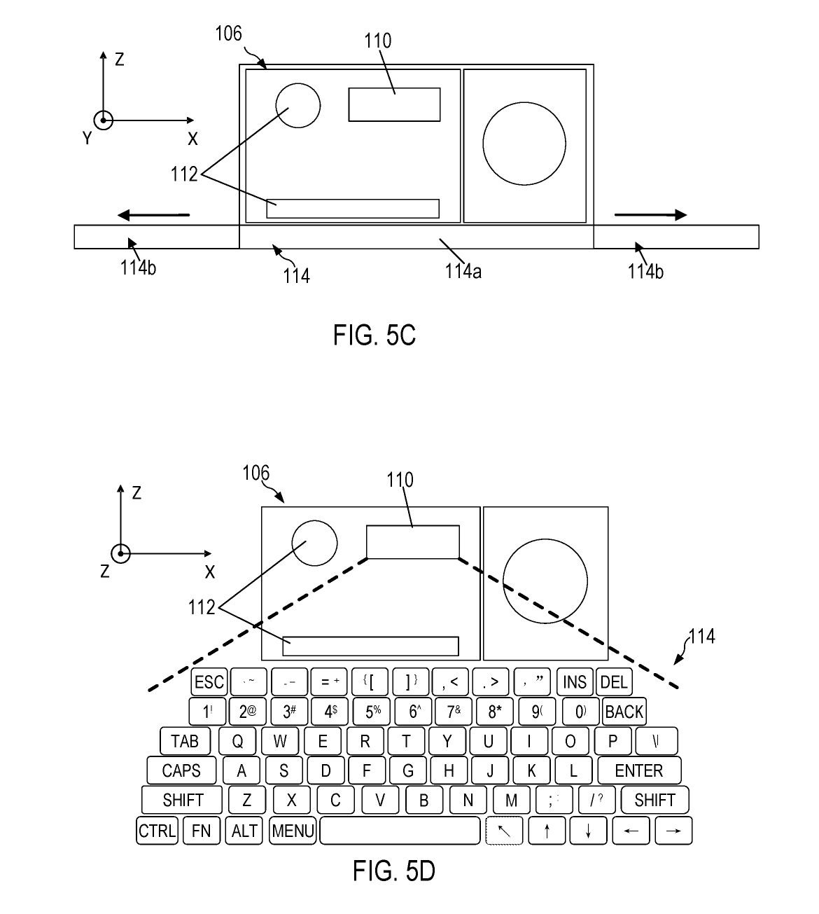

FIG. 6 shows another example of the computing device 100, according to some implementations of the present disclosure. In some implementations, as shown in FIG. 6, the laser projection keyboard 106 of the I/O device 102 may not include a retractable platform (e.g., the retractable platform 114 in FIGS. 1B and 5A-5D). In this case, the laser projection keyboard 106 may find an adjacent surface (e.g., a flat surface extending in the X-Y plane next to the I/O device 102) and project the keyboard pattern on that surface. In some implementations, as shown in FIG. 6, the projector 104 and the laser projection keyboard 106 are arranged horizontally along the X direction. Alternatively, in some other implementations, the projector 104 and the laser projection keyboard 106 can be arranged vertically along the Z direction.

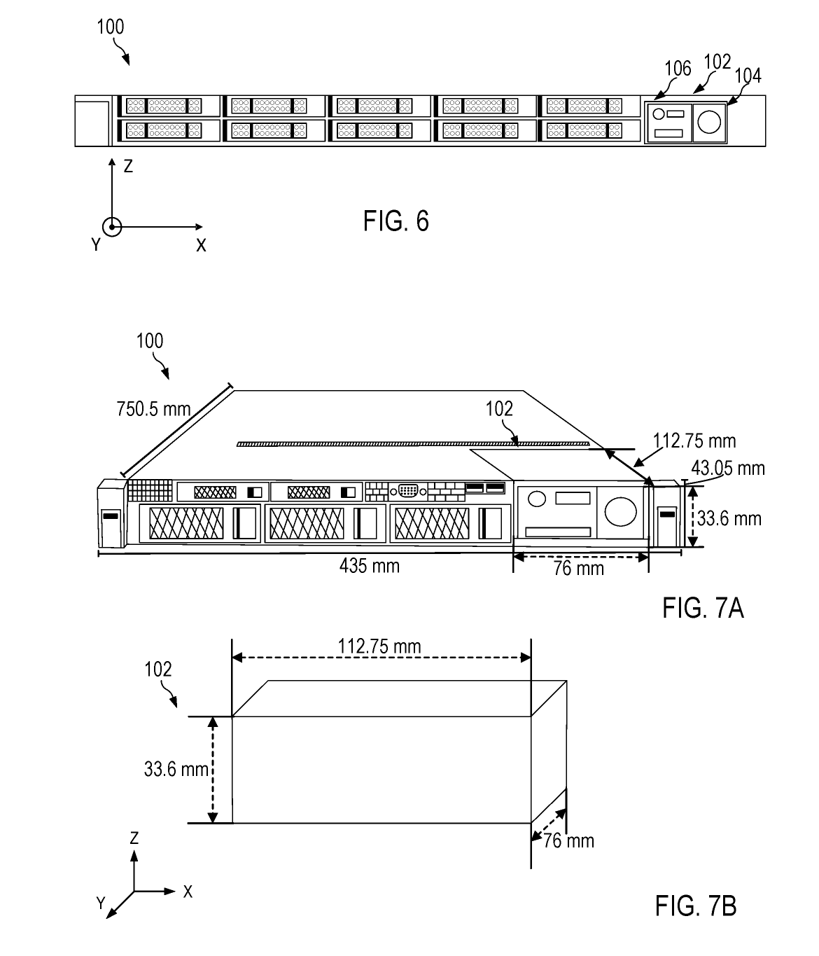

FIGS. 7A-7B show examples of a size of the computing device 100 and a size of the I/O device 102, according to some implementations of the present disclosure. A size of the computing device 100 along the X direction can be in a range between 400 millimeter (mm) and 500 mm. A size of the computing device 100 along the Y direction can be in a range between 700 mm and 800 mm. A size of the computing device 100 along the Z direction can be in a range between 40 mm and 50 mm. A size of the I/O device 102 along the X direction can be in a range between 100 mm and 120 mm. A size of the I/O device 102 along the Y direction can be in a range between 70 mm and 80 mm. A size of the I/O device 100 along the Z direction can be in a range between 30 mm and 40 mm. It is understood that the dimensions in FIGS. 7A-7B are for illustration purpose only and are not intended to be construed in a limiting sense. In practice, the computing device 100 and the I/O device 102 can have any suitable sizes.

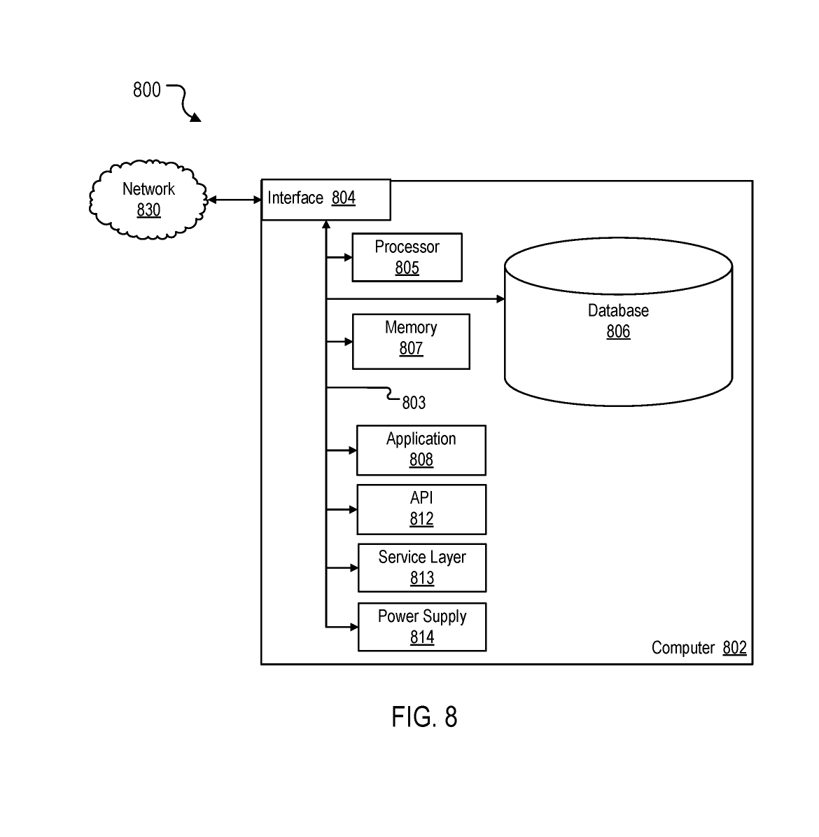

FIG. 8 is a block diagram illustrating an example of a computer-implemented System 800 used to provide computational functionalities associated with described algorithms, methods, functions, processes, flows, and procedures, according to an implementation of the present disclosure. In the illustrated implementation, computer-implemented system 800 includes a Computer 802 and a Network 830.

The illustrated Computer 802 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 802 can include an input device, such as a keypad, keyboard, or touch screen, or a combination of input devices that can accept user information, and an output device that conveys information associated with the operation of the Computer 802, including digital data, visual, audio, another type of information, or a combination of types of information, on a graphical-type user interface (UI) (or GUI) or other UI.

The Computer 802 can serve in a role in a distributed computing system as, for example, a client, network component, a server, or a database or another persistency, or a combination of roles for performing the subject matter described in the present disclosure. The illustrated Computer 802 is communicably coupled with a Network 830. In some implementations, one or more components of the Computer 802 can be configured to operate within an environment, or a combination of environments, including cloud-computing, local, or global.

At a high level, the Computer 802 is an electronic computing device operable to receive, transmit, process, store, or manage data and information associated with the described subject matter. According to some implementations, the Computer 802 can also include or be communicably coupled with a server, such as an application server, e-mail server, web server, caching server, or streaming data server, or a combination of servers.

The Computer 802 can receive requests over Network 830 (for example, from a client software application executing on another Computer 802) and respond to the received requests by processing the received requests using a software application or a combination of software applications. In addition, requests can also be sent to the Computer 802 from internal users (for example, from a command console or by another internal access method), external or third-parties, or other entities, individuals, systems, or computers.

Each of the components of the Computer 802 can communicate using a System Bus 803. In some implementations, any or all of the components of the Computer 802, including hardware, software, or a combination of hardware and software, can interface over the System Bus 803 using an application programming interface (API) 812, a Service Layer 813, or a combination of the API 812 and Service Layer 813. The API 812 can include specifications for routines, data structures, and object classes. The API 812 can be either computer-language independent or dependent and refer to a complete interface, a single function, or even a set of APIs. The Service Layer 813 provides software services to the Computer 802 or other components (whether illustrated or not) that are communicably coupled to the Computer 802. The functionality of the Computer 802 can be accessible for all service consumers using the Service Layer 813. Software services, such as those provided by the Service Layer 813, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 802, alternative implementations can illustrate the API 812 or the Service Layer 813 as stand-alone components in relation to other components of the Computer 802 or other components (whether illustrated or not) that are communicably coupled to the Computer 802. Moreover, any or all parts of the API 812 or the Service Layer 813 can be implemented as a child or a sub-module of another software module, enterprise application, or hardware module without departing from the scope of the present disclosure.

The Computer 802 includes an Interface 804. Although illustrated as a single Interface 804, two or more Interfaces 804 can be used according to particular needs, desires, or particular implementations of the Computer 802. The Interface 804 is used by the Computer 802 for communicating with another computing system (whether illustrated or not) that is communicatively linked to the Network 830 in a distributed environment. Generally, the Interface 804 is operable to communicate with the Network 830 and includes logic encoded in software, hardware, or a combination of software and hardware. More specifically, the Interface 804 can include software supporting one or more communication protocols associated with communications such that the Network 830 or hardware of Interface 804 is operable to communicate physical signals within and outside of the illustrated Computer 802.

The Computer 802 includes a Processor 805. Although illustrated as a single Processor 805, two or more Processors 805 can be used according to particular needs, desires, or particular implementations of the Computer 802. Generally, the Processor 805 executes instructions and manipulates data to perform the operations of the Computer 802 and any algorithms, methods, functions, processes, flows, and procedures as described in the present disclosure.

The Computer 802 also includes a Database 806 that can hold data for the Computer 802, another component communicatively linked to the Network 830 (whether illustrated or not), or a combination of the Computer 802 and another component. For example, Database 806 can be an in-memory or conventional database storing data consistent with the present disclosure. In some implementations, Database 806 can be a combination of two or more different database types (for example, a hybrid in-memory and conventional database) according to particular needs, desires, or particular implementations of the Computer 802 and the described functionality. Although illustrated as a single Database 806, two or more databases of similar or differing types can be used according to particular needs, desires, or particular implementations of the Computer 802 and the described functionality. While Database 806 is illustrated as an integral component of the Computer 802, in alternative implementations, Database 806 can be external to the Computer 802. The Database 806 can hold and operate on at least any data type mentioned or any data type consistent with this disclosure.

The Computer 802 also includes a Memory 807 that can hold data for the Computer 802, another component or components communicatively linked to the Network 830 (whether illustrated or not), or a combination of the Computer 802 and another component. Memory 807 can store any data consistent with the present disclosure. In some implementations, Memory 807 can be a combination of two or more different types of memory (for example, a combination of semiconductor and magnetic storage) according to particular needs, desires, or particular implementations of the Computer 802 and the described functionality. Although illustrated as a single Memory 807, two or more Memories 807 or similar or differing types can be used according to particular needs, desires, or particular implementations of the Computer 802 and the described functionality. While Memory 807 is illustrated as an integral component of the Computer 802, in alternative implementations, Memory 807 can be external to the Computer 802.

The Application 808 is an algorithmic software engine providing functionality according to particular needs, desires, or particular implementations of the Computer 802, particularly with respect to functionality described in the present disclosure. For example, Application 808 can serve as one or more components, modules, or applications. Further, although illustrated as a single Application 808, the Application 808 can be implemented as multiple Applications 808 on the Computer 802. In addition, although illustrated as integral to the Computer 802, in alternative implementations, the Application 808 can be external to the Computer 802.

The Computer 802 can also include a Power Supply 814. The Power Supply 814 can include a rechargeable or non-rechargeable battery that can be configured to be either user- or non-user-replaceable. In some implementations, the Power Supply 814 can include power-conversion or management circuits (including recharging, standby, or another power management functionality). In some implementations, the Power Supply 814 can include a power plug to allow the Computer 802 to be plugged into a wall socket or another power source to, for example, power the Computer 802 or recharge a rechargeable battery.

There can be any number of Computers 802 associated with, or external to, a computer system containing Computer 802, each Computer 802 communicating over Network 830. Further, the term “client,” “user,” or other appropriate terminology can be used interchangeably, as appropriate, without departing from the scope of the present disclosure. Moreover, the present disclosure contemplates that many users can use one Computer 802, or that one user can use multiple computers 802.

Described implementations of the subject matter can include one or more features, alone or in combination.

For example, in a first implementation, a computing device is provided. The computing device includes a control device and an I/O device coupled to the control device. The I/O device includes a projector, and the control device is configured to: determine a status of the computing device; activate the projector in response to determining that the status is abnormal; and transmit information associated with the status to the projector for display.

The foregoing and other described implementations can each, optionally, include one or more of the following features:

A first feature, combinable with any of the following features, wherein the projector comprises a detector, a light source, and one or more lenses, and the detector is configured to determine a display surface outside of the computing device.

A second feature, combinable with any of the previous or following features, wherein the projector is configured to: receive the information associated with the status from the control device; and project the information associated with the status on the display surface.

A third feature, combinable with any of the previous or following features, wherein the detector is hosted in a retractable housing and is activated when the projector is turned on, and wherein the projector further comprises a motor configured to expand the retractable housing when the projector is turned on.

A fourth feature, combinable with any of the previous or following features, wherein the I/O device further comprises a laser projection keyboard configured to detect gestures of a user and input data based on the detected gestures.

A fifth feature, combinable with any of the previous or following features, wherein the laser projection keyboard comprises a laser source, at least one motion sensor, and a retractable platform having a surface, and the laser projection keyboard is configured to: detect a pressure applied by the user; expand the retractable platform; activate the laser source and the at least one motion sensor; and project, by using the laser source, a keyboard pattern on the surface, wherein the input data is generated by using the at least one motion sensor based on interactions between the gestures and the keyboard pattern.

A sixth feature, combinable with any of the previous or following features, wherein the control device is a BMC.

A seventh feature, combinable with any of the previous or following features, wherein the computing device further comprises a convertor coupled to the BMC and the I/O device, and the convertor is configured to convert data from the I/O device to an I3C format supported by the BMC.

An eighth feature, combinable with any of the previous or following features, wherein the convertor is configured to: receive the information associated with the status of the computing device from the BMC; store the information; and transmit the information to the I/O device when the BMC is inactive.

A ninth feature, combinable with any of the previous or following features, wherein the I/O device is mounted in the computing device, and wherein a side of the I/O device is aligned with a side of the computing device and is configured to interface the projector and the laser projection keyboard with outside of the computing device.

A tenth feature, combinable with any of the previous or following features, wherein the computing device further comprises a motherboard, the motherboard comprises the control device, and the I/O device is directly connected to the motherboard or is connected to the motherboard via a cable.

In a second implementation, a computer-implemented method is provided. The computer-implemented method includes determining, by a control device, a status of a computing device. The computing device includes the control device and an I/O device coupled to the control device. The I/O device includes a projector. The computer-implemented method further includes activating, by the control device, the projector in response to determining that the status is abnormal and transmitting, by the control device, information associated with the status to the projector for display.

The foregoing and other described implementations can each, optionally, include one or more of the following features:

A first feature, combinable with any of the following features, wherein the projector comprises a detector, a light source, and one or more lenses, and the method further comprises: determining, by the detector, a display surface outside of the computing device.

A second feature, combinable with any of the previous or following features, wherein the method further comprises: receiving, by the projector, the information associated with the status from the control device; and projecting, by the projector, the information associated with the status on the display surface.

A third feature, combinable with any of the previous or following features, wherein the detector is hosted in a retractable housing, the projector further comprises a motor, and the method further comprises: activating the detector when the projector is turned on; and expanding the retractable housing by using the motor when the projector is turned on.

A fourth feature, combinable with any of the previous or following features, wherein the I/O device further comprises a laser projection keyboard, and the method further comprises: detecting, by the laser projection keyboard, gestures of a user; and inputting data based on the detected gestures.

A fifth feature, combinable with any of the previous or following features, wherein the laser projection keyboard comprises a laser source, at least one motion sensor, and a retractable platform having a surface, and the method further comprises: detecting, by the laser projection keyboard, a pressure applied by the user; expanding, by the laser projection keyboard, the retractable platform; activating, by the laser projection keyboard, the laser source and the at least one motion sensor; and projecting, by the laser projection keyboard, a keyboard pattern on the surface by using the laser source, wherein the data is generated by using the at least one motion sensor based on interactions between the detected gestures and the keyboard pattern.

A sixth feature, combinable with any of the previous or following features, wherein the control device is a BMC.

A seventh feature, combinable with any of the previous or following features, wherein the computing device further comprises a convertor coupled to the BMC and the projector, wherein the method further comprises: converting, by the convertor, data from the I/O device to an I3C format supported by the BMC.

In a third implementation, a non-transitory computer readable computer-readable medium is provided. The non-transitory computer readable computer-readable medium stores program instructions to perform operations comprising: determining, by a control device, a status of a computing device, wherein the computing device comprises the control device and an I/O device that comprises a projector; activating, by the control device, the projector in response to determining that the status is abnormal; and transmitting, by the control device, information associated with the status to the projector for display.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual’s action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user’s mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computing device, comprising:
a control device; and
an input/output (I/O) device coupled to the control device, wherein the I/O device comprises a projector, and wherein the control device is configured to:
determine a status of the computing device;
activate the projector in response to determining that the status is abnormal; and
transmit information associated with the status to the projector for display.

2. The computing device of claim 1, wherein the projector comprises a detector, a light source, and one or more lenses, and the detector is configured to determine a display surface outside of the computing device.

3. The computing device of claim 2, wherein the projector is configured to:
receive the information associated with the status from the control device; and
project the information associated with the status on the display surface.

4. The computing device of claim 2, wherein the detector is hosted in a retractable housing and is activated when the projector is turned on, and wherein the projector further comprises a motor configured to expand the retractable housing when the projector is turned on.

5. The computing device of claim 1, wherein the I/O device further comprises a laser projection keyboard configured to detect gestures of a user and input data based on the detected gestures.

6. The computing device of claim 5, wherein the laser projection keyboard comprises a laser source, at least one motion sensor, and a retractable platform having a surface, and the laser projection keyboard is configured to:
detect a pressure applied by the user;
expand the retractable platform;
activate the laser source and the at least one motion sensor; and
project, by using the laser source, a keyboard pattern on the surface, wherein the input data is generated by using the at least one motion sensor based on interactions between the gestures and the keyboard pattern.

7. The computing device of claim 1, wherein the control device is a baseboard management controller (BMC).

8. The computing device of claim 7, wherein the computing device further comprises a convertor coupled to the BMC and the I/O device, and the convertor is configured to convert data from the I/O device to an improved inter-integrated circuit (I3C) format supported by the BMC.

9. The computing device of claim 8, wherein the convertor is configured to:
receive the information associated with the status of the computing device from the BMC;
store the information; and
transmit the information to the I/O device when the BMC is inactive.

10. The computing device of claim 5, wherein the I/O device is mounted in the computing device, and wherein a side of the I/O device is aligned with a side of the computing device and is configured to interface the projector and the laser projection keyboard with outside of the computing device.

11. The computing device of claim 1, further comprising a motherboard, wherein the motherboard comprises the control device, and the I/O device is directly connected to the motherboard or is connected to the motherboard via a cable.

12. A computer-implemented method, comprising:
determining, by a control device, a status of a computing device, wherein the computing device comprises the control device and an input/output (I/O) device coupled to the control device, and the I/O device comprises a projector;
activating, by the control device, the projector in response to determining that the status is abnormal; and
transmitting, by the control device, information associated with the status to the projector for display.

13. The method of claim 12, wherein the projector comprises a detector, a light source, and one or more lenses, and the method further comprises:
determining, by the detector, a display surface outside of the computing device.

14. The method of claim 13, further comprising:
receiving, by the projector, the information associated with the status from the control device; and
projecting, by the projector, the information associated with the status on the display surface.

15. The method of claim 13, wherein the detector is hosted in a retractable housing, the projector further comprises a motor, and the method further comprises:
activating the detector when the projector is turned on; and
expanding the retractable housing by using the motor when the projector is turned on.

16. The method of claim 12, wherein the I/O device further comprises a laser projection keyboard, and the method further comprises:
detecting, by the laser projection keyboard, gestures of a user; and
inputting data based on the detected gestures.

17. The method of claim 16, wherein the laser projection keyboard comprises a laser source, at least one motion sensor, and a retractable platform having a surface, and the method further comprises:
detecting, by the laser projection keyboard, a pressure applied by the user;
expanding, by the laser projection keyboard, the retractable platform;
activating, by the laser projection keyboard, the laser source and the at least one motion sensor; and
projecting, by the laser projection keyboard, a keyboard pattern on the surface by using the laser source, wherein the data is generated by using the at least one motion sensor based on interactions between the detected gestures and the keyboard pattern.

18. The method of claim 12, wherein the control device is a baseboard management controller (BMC).

19. The method of claim 18, wherein the computing device further comprises a convertor coupled to the BMC and the projector, wherein the method further comprises:
converting, by the convertor, data from the I/O device to an improved inter-integrated circuit (I3C) format supported by the BMC.

20. A non-transitory computer-readable medium storing program instructions to perform operations comprising:
determining, by a control device, a status of a computing device, wherein the computing device comprises the control device and an input/output (I/O) device that comprises a projector;
activating, by the control device, the projector in response to determining that the status is abnormal; and
transmitting, by the control device, information associated with the status to the projector for display.
